(19) United States
(12) Patent Application Publication
(10) Pub. No.: US 2014/0358971 A1
(43) Pub. Date: Dec. 4, 2014

(54) Techniques for identifying chain businesses and queries

(71) Applicants: Daniel Aminzade, New York, NY (US); Luis Castro, Piscataway, NJ (US); Xiaoqun Du, Jersey City, NJ (US); Anjali Koppal, New York, NY (US)

(72) Inventors: Daniel Aminzade, New York, NY (US); Luis Castro, Piscataway, NJ (US); Xiaoqun Du, Jersey City, NJ (US); Anjali Koppal, New York, NY (US)

(73) Assignee: GOOGLE INC., Mountain View, CA (US)

(21) Appl. No.: 12/907,227

(22) Filed: Oct. 19, 2010

(51) Int. Cl. G06F 17/30

(52) U.S. Cl. 707/780; 707/E17.014

(57) ABSTRACT

Aspects of the invention relate generally to providing useful search results from chain business queries. More specifically, various algorithms may be used to identify chain businesses and queries for chain businesses. Chain businesses may include, for example, various types of businesses which are associated with other businesses with the same name, such as chain restaurants, car rental locations, pharmacies, banks, retail stores, or other franchise businesses. This information may be used to rank and filter search results as well as incorporate other useful features in order to improve a user's search experience.

### BACKGROUND OF THE INVENTION

Various network-based search applications allow a user to enter search terms and receive a list of search results. The systems use numerous different types of ranking algorithms to ensure that the search results are relevant to the user's query. For example, some systems such as Google Search rank results based on reliability and safety of the search result, location of the user and search result, etc. If the system understands that the user is searching for a business, the search application may also identify a list of local businesses based on the user's location. However, in order for the system to identify the search query as a business, the application must pre-determine which queries, or the search terms themselves, refer to businesses. However, these systems may not be able to distinguish between different types of businesses, such as between chain businesses and non-chain businesses.

Some search systems may filter or rank search results based on a localness factor. For example, the Google web search application may make a comparison of a percentage of web searches using a particular query to a percentage of map searches using the same query. These comparisons may then be used to determine how likely it is that the user is interested in local businesses. Based on this information, Google ranks and returns a list of the most relevant search results.

### BRIEF SUMMARY OF THE INVENTION

Aspects of the invention relate generally to providing useful search results based on chain business queries. More specifically, various algorithms may be used to identify chain businesses and queries for chain businesses. Chain businesses may include, for example, various types of businesses which are associated with other businesses with the same name, such as chain restaurants, car rental locations, pharmacies, banks, retail stores, or other franchise businesses. As noted above, this information may be used to rank and filter search results as well as incorporate other useful features in order to improve a user's search experience.

One aspect of the invention provides a computer-implemented method. The method includes identifying, by a processor of a computer, a trigger term which is indicative of a chain business query; accessing historical search data for a plurality of queries, each query being associated with a search term, a list of search results, and a selected search result; identifying one or more queries of the historical search data associated with the trigger term; identifying the one or more selected search results associated with the identified one or more queries; the processor generating a table of chain business terms based on the identified one or more queries and the identified one or more selected search results; and storing the table in memory.

In one example, the method also includes receiving, from a processor of a second computer, a request including a received search term; and comparing the received search term to the table of chain business terms to determine if the received search term is a chain business term. In another example, the method also includes identifying a selected search result from the table if the received search term is a chain business term. In another example, the method also includes receiving the location of the second computer; if the received search term is a chain business term, identifying a chain business based on the received search term; identifying one or more business locations associated with the identified chain business; determining, based on the received location, a closest business location of the one or more business locations closest to the client device; and transmitting for display on the second computer a map identifying the closest business location and a list of search results. In another example, the method also includes identifying a chain query based on the historical search data and the one or more selected search results; and including the chain query and the one or more selected search results in the table of chain business terms.

Another aspect of the invention provides a computer-implemented method. The method includes generating, by a processor of a computer, a list of possible chain businesses based on entity information identifying a plurality of businesses, each business being associated with a title identifying a name of the business; accessing historical search data for a plurality of geographic queries, each query being associated with a search term; selecting a business of the list of possible chain businesses and a corresponding title; identifying a number of businesses based on businesses of the entity information associated with the selected title; identifying a number of unique queries of the historical search data where the associated search term includes the selected title; the processor determining a value based on the number of businesses and the number of unique queries; and determining that the selected title is a chain business title where the determined value is greater than a threshold value.

In one example, the method also includes determining that the selected title is not a chain business title where the ratio of the number of unique queries to the number of businesses is less than a threshold value. In another example, the method also includes removing the selected business from the list of possible chain businesses. In another example, the method also includes designating the selected business as a chain business if the ratio of the number of unique queries to the number of businesses is greater than a threshold value. In another example, the value is a ratio of the number of businesses to the number of unique queries.

Yet another aspect of the invention provides computer-implemented method. The method includes generating, by a processor of a computer, a list of possible chain businesses based on entity information identifying a plurality of businesses, each business being associated with a title identifying a name of the business; accessing historical search data for a plurality of geographic queries, each query being associated with a search term and being either a map query for map-related information or a web query; selecting a business of the list of possible chain businesses and a corresponding title; determining a value based on a number of map queries associated with a search term including the title and a number of web queries associated with a search term including the title; and determining that the selected title is a chain business title where the determined value is greater than a threshold value.

In one example, the method also includes determining that the selected title is not a chain business title where the determined value is less than a threshold value. In another example, the method also includes removing the selected business from the list of possible chain businesses. In another example, the method also includes, designating the selected business as a chain business if the determined value is greater than a threshold value. In another example, the value is a ratio of the number of map queries associated with a search term including the title to the number of web queries associated with a search term including the title.

Still another aspect of the invention provides a computer-implemented method. The method includes generating, by a processor of a computer, a list of possible chain businesses based on entity information identifying a plurality of businesses, each business being associated with title information identifying a name of the business and category information describing the type of business; selecting a business of the list of possible chain businesses and a corresponding title; identifying from the entity information a number T of businesses associated with category information including the selected title; identifying from the entity information a number C of businesses associated with title information including the selected title; determining a value based on the number T and the number C; and determining that the selected title is a chain business title where the determined value is less than a threshold value.

In one example, the method also includes determining that the selected title is not a chain business title where the determined value is greater than a threshold value. In another example, the method also includes removing the selected business from the list of possible chain businesses. In another example, the method also includes designating the selected business as a chain business if the determined value is less than a threshold value. In another example, the value is a ratio of the number T to the number C.

### BRIEF DESCRIPTION OF THE DRAWINGS

FIG. 1 is a functional diagram of a system in accordance with an aspect of the invention.

FIG. 2 is a pictorial diagram of a system in accordance with an aspect of the invention.

FIG. 3 is an exemplary screen shot in accordance with an aspect of the invention.

FIG. 4 is an exemplary screen shot in accordance with an aspect of the invention.

FIG. 5 is an exemplary screen shot in accordance with an aspect of the invention.

FIG. 6 is a table of exemplary data in accordance with an aspect of the invention.

FIG. 7 is an exemplary screen shot in accordance with an aspect of the invention.

FIG. 8 is an exemplary screen shot in accordance with an aspect of the invention.

FIG. 9 is an exemplary flow diagram in accordance with an aspect of the invention.

FIG. 10 is an exemplary flow diagram in accordance with an aspect of the invention.

FIG. 11 is an exemplary flow diagram in accordance with an aspect of the invention.

FIG. 12 is an exemplary flow diagram in accordance with an aspect of the invention.

### DETAILED DESCRIPTION

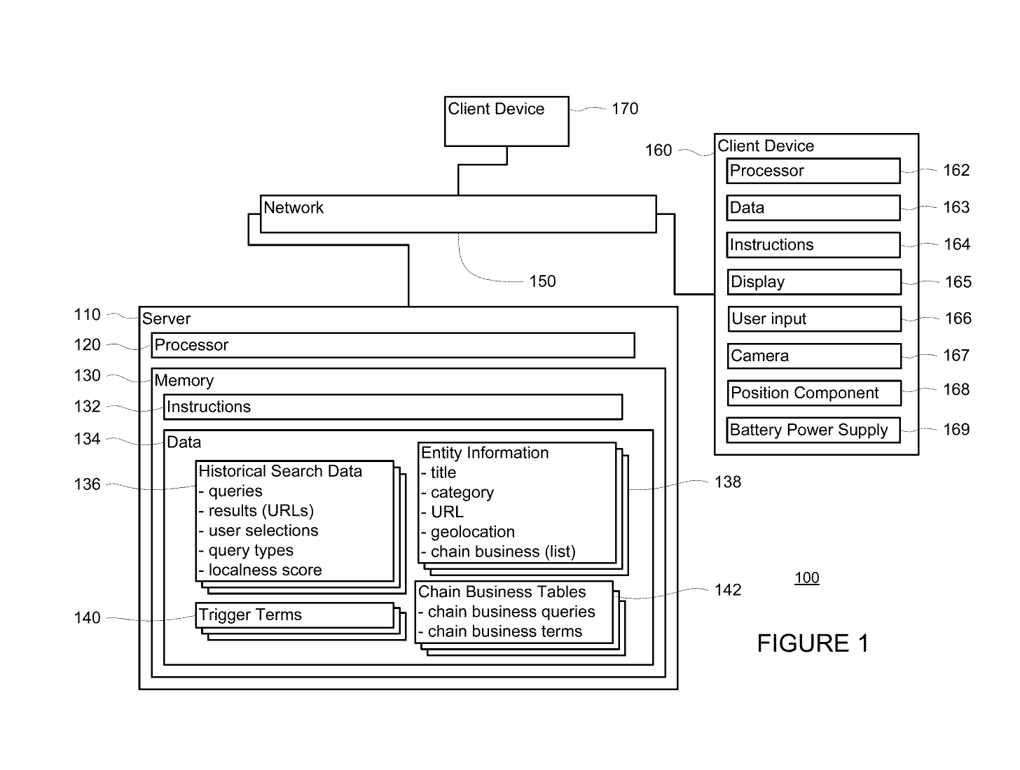

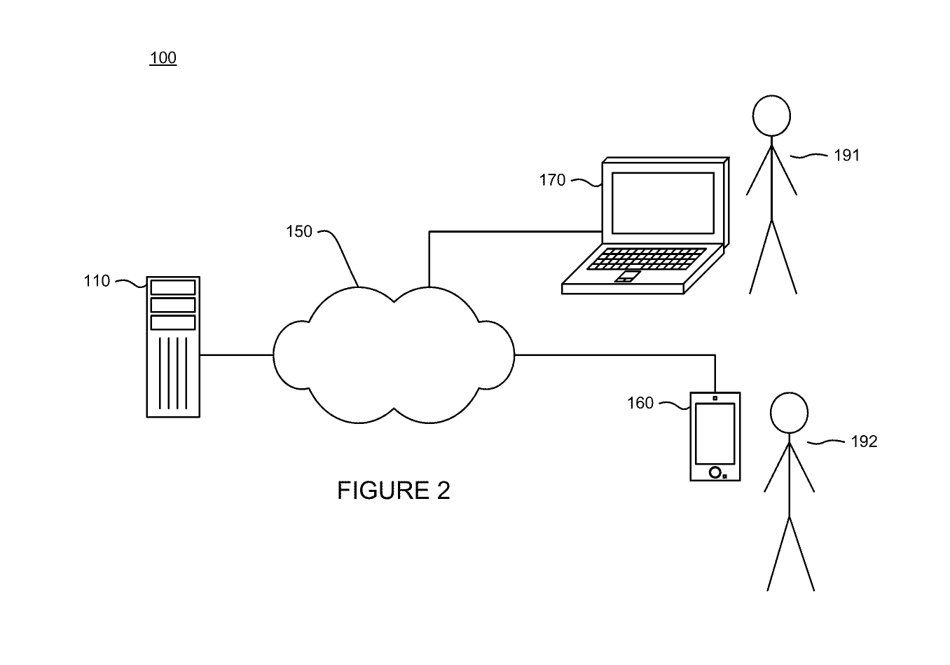

As shown in FIGS. 1-2, a system 100 in accordance with one aspect of the invention includes a computer 110 containing a processor 120, memory 130 and other components typically present in general purpose computers.

The memory 130 stores information accessible by processor 120, including instructions 132, and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, memory may include short term or temporary storage as well as long term or persistent storage. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the architecture is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as processors from Intel Corporation or Advanced Micro Devices. Alternatively, the processor may be a dedicated controller such as an ASIC. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor or computer will be understood to include references to a collection of processors or computers or memories that may or may not operate in parallel.

The computer 110 may be at one node of a network 150 and capable of directly and indirectly receiving data from other nodes of the network. For example, computer 110 may comprise a web server that is capable of receiving data from client devices 160 and 170 via network 150 such that server 110 uses network 150 to transmit and display information to a user on display 165 of client device 170. Server 110 may also comprise a plurality of computers that exchange information with different nodes of a network for the purpose of receiving, processing and transmitting data to the client devices. In this instance, the client devices will typically still be at different nodes of the network than any of the computers comprising server 110.

Network 150, and intervening nodes between server 110 and client devices, may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Although only a few computers are depicted in FIGS. 1-2, it should be appreciated that a typical system can include a large number of connected computers.

Each client device may be configured similarly to the server 110, with a processor, memory and instructions as described above. Each client device 160 or 170 may be a personal computer intended for use by a person 191-192, and have all of the components normally used in connection with a personal computer such as a central processing unit (CPU) 162, memory (e.g., RAM and internal hard drives) storing data 163 and instructions 164, an electronic display 165 (e.g., a monitor having a screen, a touch-screen, a projector, a television, a computer printer or any other electrical device that is operable to display information), end user input 166 (e.g., a mouse, keyboard, touch-screen or microphone). The client device may also include a camera 167, accelerometer, speakers, a network interface device, a battery power supply 169 or other power source, and all of the components used for connecting these elements to one another.

As shown in FIG. 1, the client devices may also include geographic position component 168, to determine the geographic location and orientation of the device. For example, client device 170 may include a GPS receiver to determine the device's latitude, longitude and altitude position. Thus, as the client device changes location, for example by being physically moved, the GPS receiver may determine a new current location. The component 168 may also comprise software for determining the position of the device based on other signals received at the client device 170, such as signals received at a cell phone's antennas from one or more cell phone towers if the client device is a cell phone.

Although the client devices 160 and 170 may each comprise a full-sized personal computer, they may alternatively comprise mobile devices capable of wirelessly exchanging data, including position information derived from position component 168, with a server over a network such as the Internet. By way of example only, client device 160 may be a wireless-enabled PDA or a cellular phone capable of obtaining information via the Internet. The user may input information using a small keyboard (in the case of a Blackberry-type phone), a keypad (in the case of a typical cellular phone) or a touch screen (in the case of a PDA).

Data 134 of server 110 may include historical search data 136. The search data may be compiled over several days, weeks, or months. In one example, the historical data is related to a map search function where users may search for businesses or items and receive information and maps for one or more geographic locations. The data may include search queries, associated search results, which URL (result) the user selected upon receiving the search results, and other information. The historical search data may be used to identify various patterns and associations between search results as described below.

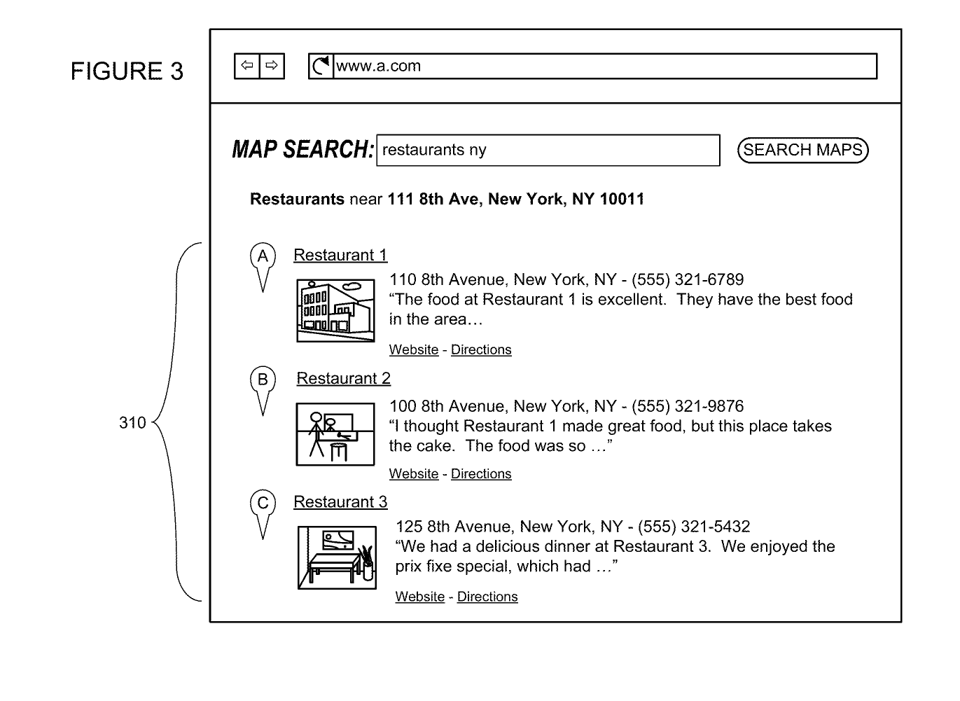

The historical search data may be classified into various map query types. In one embodiment, the historical data 136 may include web search engine queries and/or map search engine queries. Some map queries may be considered “categorical queries” or queries the users enters when searching for results under a broad category. As shown in FIG. 3, a user may search for a category such as “restaurants” and a location “111 8th Ave NY.” In response, the server may provide a variety of results 310 that represent a range of options within the category.

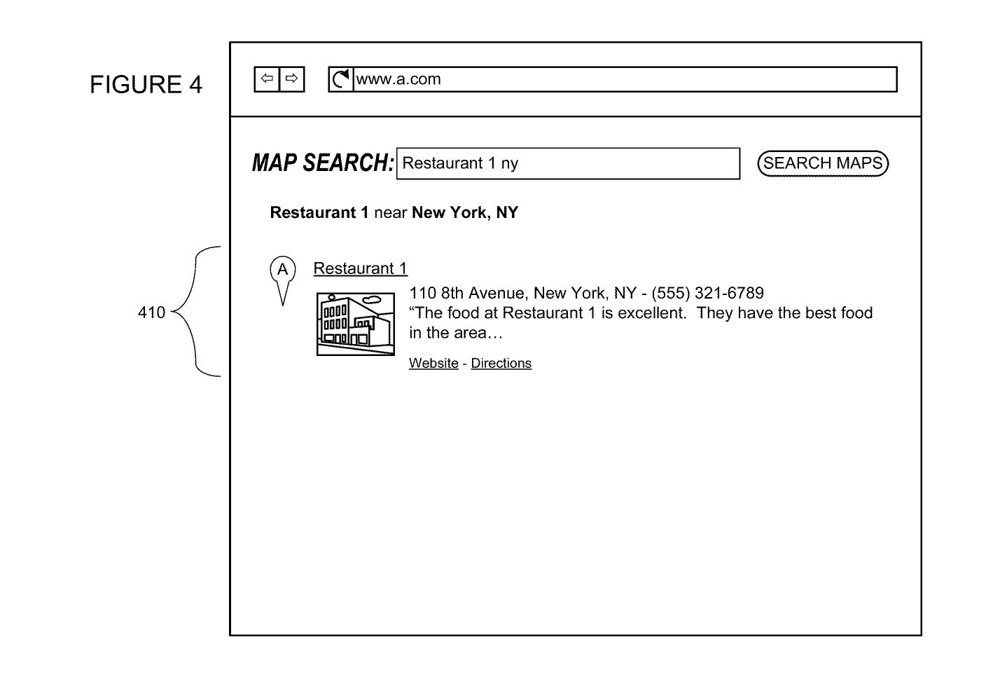

In another example, map queries may be considered “navigational queries” or queries the user enters when searching for one, specific example. As shown in FIG. 4, the user searched for “Restaurant 1 NY.” If “Restaurant 1” is the name of a particular restaurant in New York, N.Y., the server may provide a single result 410.

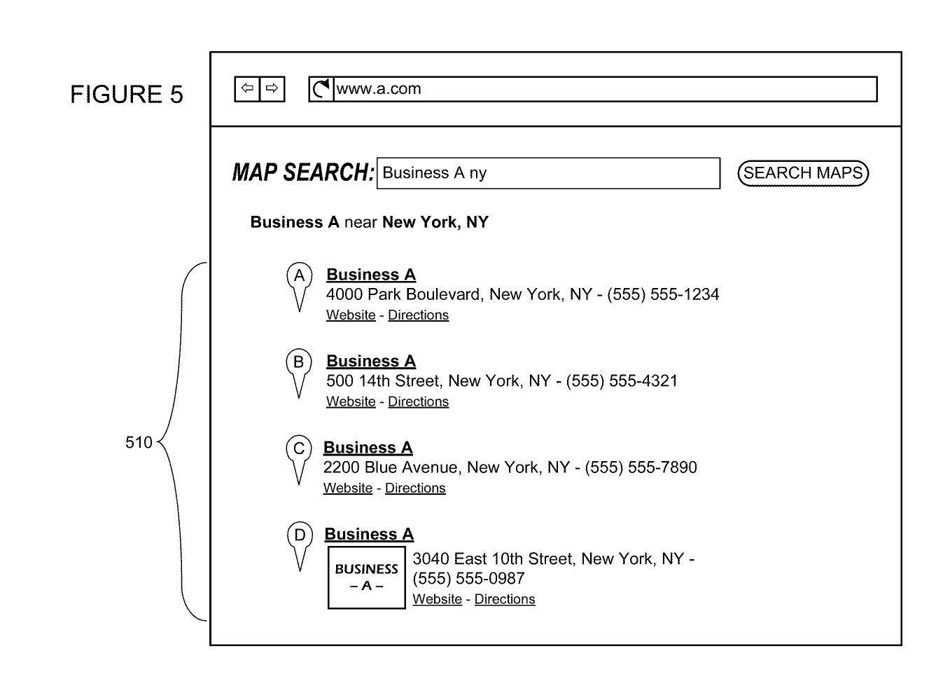

In another example, map queries may be considered “chain business queries” where the user searches for a particular chain business. For example, a user may search for a chain business such as “Business A.” The user's client device may transmit location information such as an IP address, geographical address, or latitude and longitude coordinates to the server. In response, as shown in FIG. 5, the server may provide a list of results 510 ranked by various factors including, for example, by increasing distance from the user (or the user's client device) and/or how famous or well-recognized the business is.

The historical search data may also include “localness” scores. A localness score may identify the likelihood that a particular query has local intent. For example, for a given query, the ratio of the query's popularity on a local search, such as a map search, to its popularity on a web search may be computed. For example, if the query “burger king” represented 2% of daily local or map search queries but only 0.1% of web queries, it may be associated with a relatively high localness score, such as 20. As will be described in more detail below, the localness score may be used to identify chain businesses.

The server 110 may also access entity information 138 identifying local businesses, clubs, or other objects or features associated with particular geographic locations. In some examples, the entity information may include information identifying chain businesses, in other works, a list of chain businesses. The entity information may be compiled from a plurality of data providers, such as the businesses themselves, business listing websites, or data contributed by users or other third parties. An entity may be associated with a name or title (such as “Tom's Pizzaria”), a category (such as “pizza”, “Italian restaurant” or “ballpark”), a geographic location (such as “123 Main Street” or latitude and longitude), and various other types of information. As the titles and categories are generated by the individual data provider, business, or detected by the server itself, it will be understood that these terms are for the most part not standardized. An entity may also be associated with links to the entity's website, user reviews, images, phone numbers, links to additional information pages, etc.

Data 134 of server 110 may also include a list of trigger terms 140. The trigger words may include words that users commonly use in “chain businesses queries.” For example, considering chain business “A” and chain business “B”, some examples of such trigger terms in English may be “locations” or “store locator,” as many users issue queries such as “A store locator” or “B locations.” Other examples of useful English trigger terms may include “branches” or “branch locations.” It will be understood that although only English examples are used, the present invention may be used with any number of additional languages used by search users. For example, the French word “magasins,” which translates in English to “stores,” may be used as a trigger term for queries issued in French.

These trigger terms may be manually specified or by beginning with a list of known chain business names and searching the historical search data for terms which most frequently occur together with the known chain business names.

Server 110 may also have access to one or more chain business tables 142. The chain business tables may include various information identifying chain businesses and chain business queries. For example, a chain business query table may identify a search query and the associated language of a search, a potential chain business URL, and the number of times the URL was selected as a result of a search using the search query: [language, potential chain business URL, count]. In another example, a chain business term table may include a list of identified chain businesses, URLs, and the number of times the query has been used and the user selected the URL: [URL, chain business term, count]. As will be described in more detail below, this information may be used to filter and rank search results and activate various features.

In addition to the operations described below and illustrated in the figures, various operations in accordance with aspects of the invention will now be described. It should also be understood that the following operations do not have to be performed in the precise order described below. Rather, various steps can be handled in a different order or simultaneously.

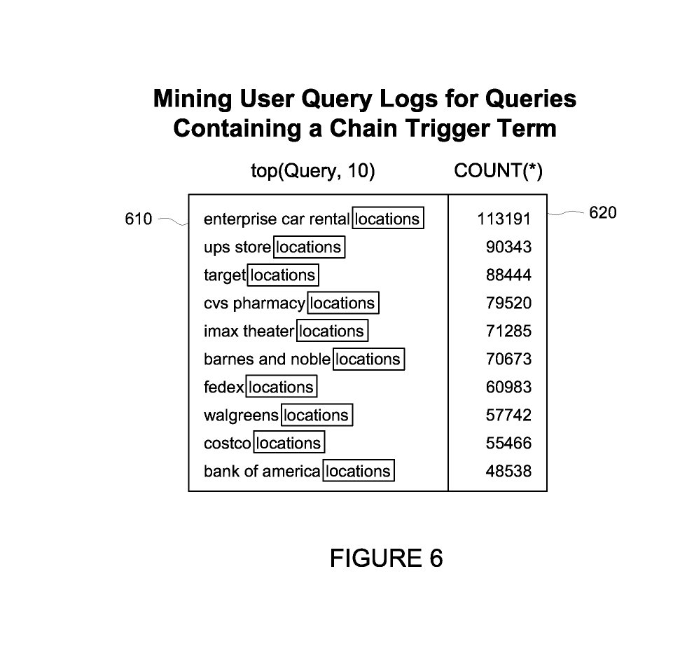

In one embodiment, the server may use the trigger terms 140 to identify the most popular results (or frequently occurring URLs) for queries containing the trigger words. For example, server 110 may use the trigger terms to pull information from the historical data 136. If the trigger term is “locations,” server 110 may identify queries such as “walmart locations.” FIG. 6 depicts exemplary log data for the trigger term “locations” 610. The data also includes counts 620 representing the number of time the user selects a URL associated with the business. Accordingly, server 110 may also identify the URLs which a user selected after entering the identified query.

To obtain a larger number of useful results, the historical data may be recorded, for example, over the previous three-month period, though it will be understood that other, much longer or shorter, data periods may be used.

In order to limit the identified search queries and associated URLs to the most likely chain businesses, the server may select only the most popular high “navigational” results. For example, the server may receive a particular search query from a plurality of users. The navigational result may be described as the preferred search result or the search result selected or clicked on by the greatest percentage of users submitting the particular search query. For example, a search for the query “Business A” may provide a list of results including http://www.a.com (the web site for Business A) and http://www.z.com/BusinessA (a social network website with information about Business A). The website http://www.a.com may be a navigational result whereas http://www.z.com/BusinessA may not be highly navigational, that is, users may not click on it enough times to meet the threshold percentage. Navigational results may be identified based on reviewing historical data to determine the fraction of the number of times an identified query and a selected result appear together in the historical data. The server may identify URLs based on queries from the historical search data which (1) contain the trigger term and (2) where the URL is one of the top three listed query results with a relatively high click rate (rate of selection by users) or one that meets a particular threshold percentage such as a 50 percent or greater click rate

For example, the server uses the trigger term “locations” and receives 400 search queries including the search terms “A locations” and 400 search queries including the search terms “A store locations” (where “A” is presumably the name of a chain business) as an English search request. If the users selected http://www.a.com/storelocations 303 times for the “A locations” query and 222 times for the “A store location” query, then the identified data may include: [en, http://www.a.com/storelocations, 303] and [en, http://www.a.com/storelocations, 222]. If the navigational threshold percentage is 50%, then the server may identify both of the queries, “A locations” and “A store locations” as chain business queries. As noted above, this data may be stored by server 110, for example, as one or more chain business tables.

The server may then use the data to identify chain business queries in the same language. For example, the server may remove the trigger terms from the identified search queries to identify chain businesses. The server may remove the term “locations” from the search queries “A locations” to obtain a result, “A.” The result is then identified as a chain business query and may be stored in the chain business tables.

However, it may not be sufficient to simply remove the trigger term from the set of queries to identify the chain business term, for example, removing “locations” from “A locations,” as this will not provide a complete set of variations such as misspellings or alternative spellings, of a chain business's name and search queries used by users. For example, the queries “A tires” or “A exterminator” may be chain business queries, but neither query includes a trigger term.

In order to identify additional chain queries, the server may use the identified URLs to identify queries with navigational results or which resulted in an identified URL one of the top, for example, three results. This may allow the server to identify the popular variations in search queries for a particular chain business. For example, chain business A-mart may also be searched as “Amart”, “A-mart superstore”, etc. For example, the server may identify http://www.a.com/storelocations as a navigational result for the search query “A store locations” and a chain business URL for Business A. Based on this, the server may also identify additional queries, such as “A tires” or “A exterminator” which included this website as a navigational result or one of the top three displayed results as chain business queries. These identified chain business queries may then be included in the chain business tables. If the URL http://www.a.com/storelocations, is included in the top three results of a particular query, such as “A NY,” but had a low selection rate for the particular query, the particular query may be excluded from possible chain store queries and the server may not include it in the chain business table.

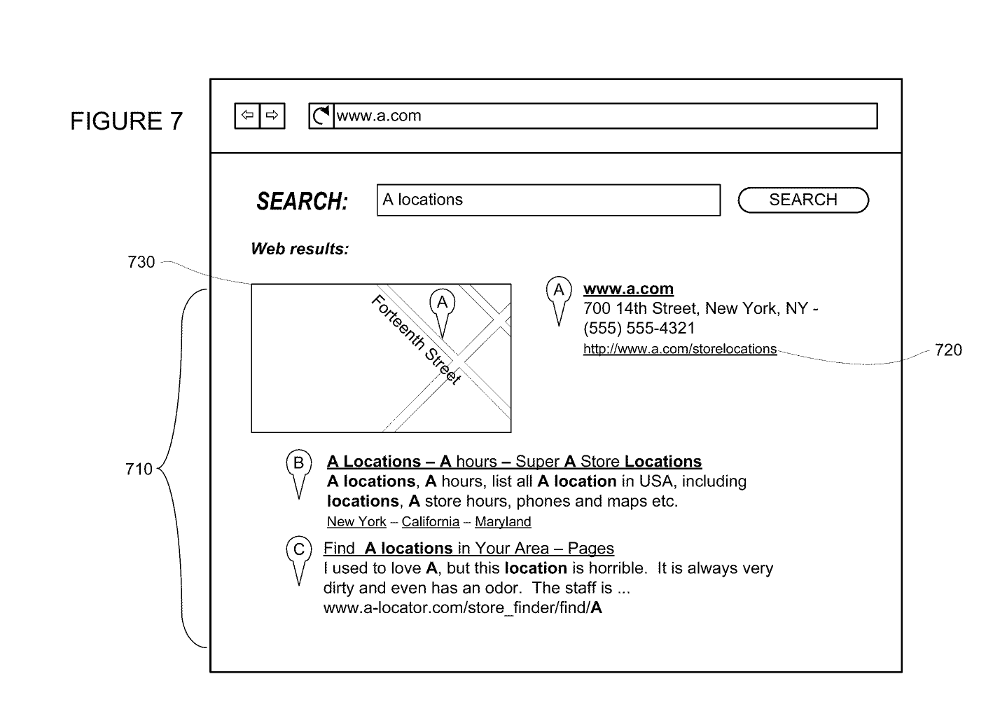

The identified results and tables may be used by the server in various ways. In one example, the server may use the chain business term table to identify whether an incoming query is related to a chain business and provide one or more search results accordingly. For example, with regard to FIG. 7, in response to receiving the web search query “a locations” the server may use the table to determine that “a” has been identified as a chain business term. Thus, the server may designate the query as a chain business query and include http://www.a.com/storelocations as the first search result 720 of a plurality of search results 710. If the server receives geolocation information from the user's client device, the server may also include a map 730 identifying the chain location nearest to the requesting user's current location as shown in FIG. 7.

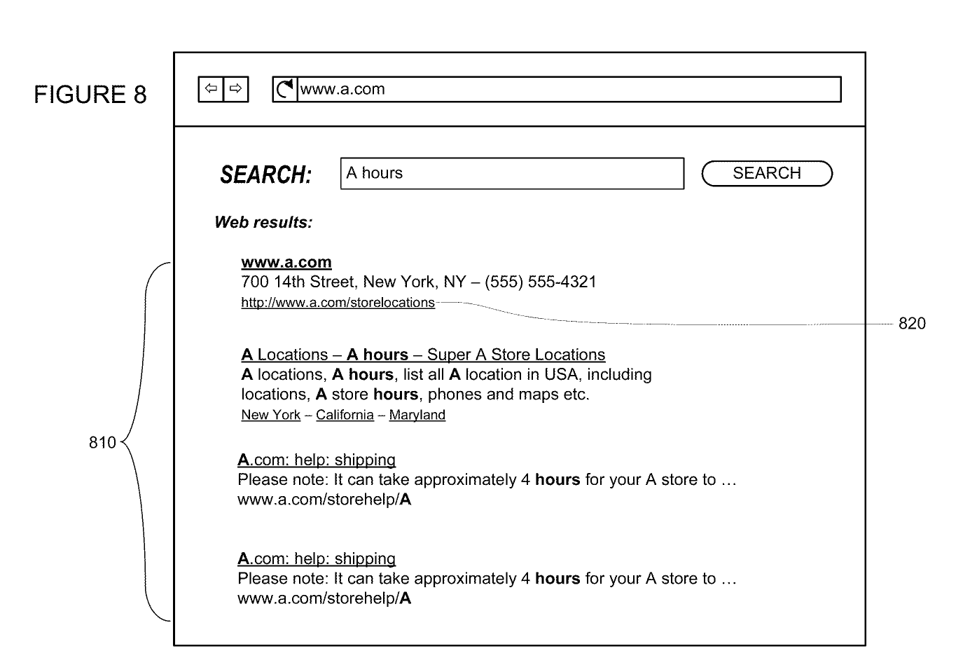

In another example, with regard to FIG. 8, the server may receive the web search query “a hours.” The server may use the table to determine that “a” has been identified as a chain business term. Again, the server may designate the query as a chain business query and return the URL http://www.a.com/storelocations as the first result 820 or one of the first few search results 810 as shown in FIG. 8. In addition, as described above, the server may identify how to present map search results based on the table data (whether or not the search is a “chain business query”) as shown in FIG. 5.

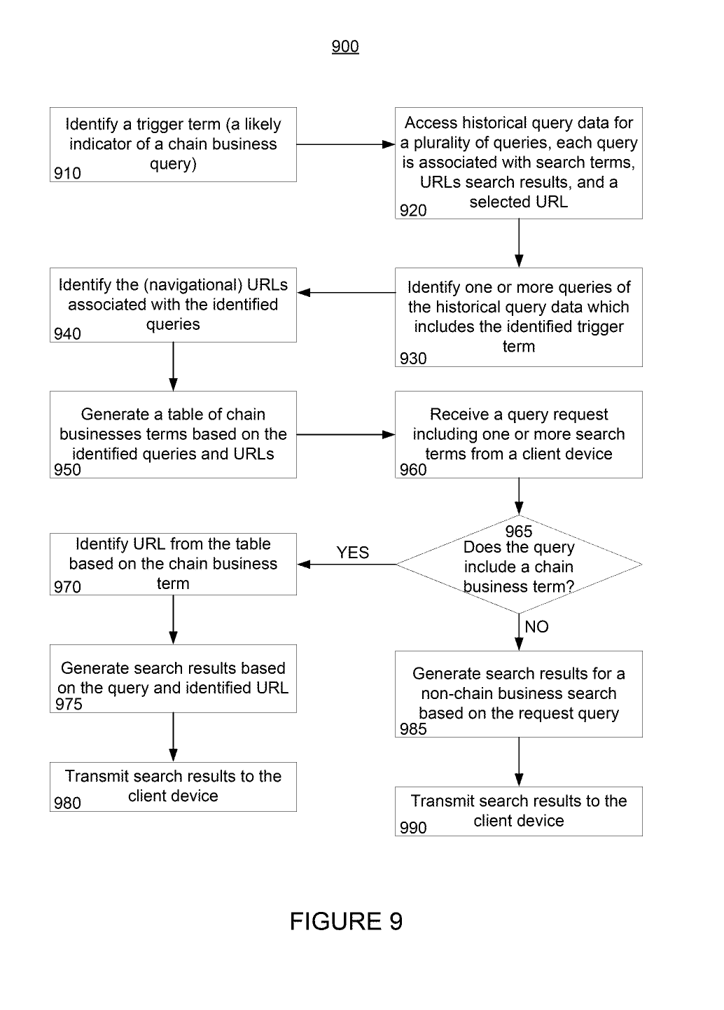

As shown in process 900 of FIG. 9, the server identifies a trigger term which is likely to indicate a chain business query at block 910. The server then accesses historical query data for a plurality of queries, each query being associated with search terms, URL search results, and a selected URL at block 920. Using the historical query data, the server identifies one or more queries which include the identified trigger term at block 930. The server then identifies the URLs associated with the identified queries and uses this information to generate a table of chain business terms at blocks 940 and 950, respectively. The server then receives a query request including one or more search terms from a client device and determines whether the query includes a chain business term at blocks 960 and 965, respectively. If the query does include a chain business term, the server will identify a URL form the table of chain businesses based on the chain business term of the query at block 970. The server also generates search results based on the query and the identified URL and transmits the search results to the client device at blocks 975 and 980, respectively. If the request does not include a chain business term, the server will generate search results for a non-chain business search based on the query and transmit the search results to the client device at blocks 985 and 990, respectively.

The server may also use the table data to identify chain businesses from the entity information. For example, once the server has identified the data [http://www.a.com/storelocations, A, 525], the server may designate the businesses of entity information 138 identified by “A” as a chain business.

In addition to using the steps above, the server may also use other methods to identify chain businesses of entity information 138 of FIG. 1 and include this information in a chain business table. For example, the server may identify a list of perceived chain businesses from the entity information by identifying businesses which share the same title. However, simply assuming that all businesses sharing their title with other businesses are chains may have some disadvantages, as some entities may have multiple titles or categories from different sources and, as noted above, these terms are not standardized. For example, a number of businesses may have names that are simply generic terms, such as “pancakes” or “flowers,” but may not actually be chain businesses. Similarly, a number of businesses which are not associated with one another may use the title “pizzeria”. Thus, in order to avoid labeling such entities as chain businesses, the server may apply various statistics derived from the historical data to filter these common terms. In one example, the server may filter the list of perceived chain businesses or identify chain businesses based on a ratio of the number of unique geographical locations for which a query was issued to the number of entities sharing the same title or category. For example, the server identifies common title terms, such as “starbucks”, from the entity information. The server may compare the number of unique Starbucks locations for which the query “starbucks” was used (either explicitly in the query or implicitly from the viewport) to the number of entities sharing the name “starbucks”. The viewport may refer to a portion of the world map that the user is looking at entering a query. For example, if the user has the map centered on Chicago, Ill., when typing the query “starbucks”, the location is considered (implicitly) to be Chicago. If the user types a query with an explicit location specified like “starbucks in San Antonio” then that explicit location, San Antonio, is used, instead of the viewport. Both implicit and explicit locations may be included in the count of distinct locations for the term “starbucks”.

If the ratio is relatively high, the entity may be designated as chain businesses. Similarly, if the ratio is relatively low, the entity may be designated as a non-chain business. The server also may designate an entity as a chain business if the ratio is greater than a threshold value or some reasonable cut-off value. For example, if the threshold is 2.0, any ratios greater than or equal to 2.0 may be assumed to be general terms as there are lots of unique locations but not many listings with that title. If the ratio is below 2.0, the term is much more likely to be a chain business query as there are at least half as many listings with the name as locations for the query. This is because chain queries may have a high number of unique locations and chain businesses may generally have many entities sharing the same title.

In one example, on average, there may be 20469 queries each day for “Starbucks”. These “Starbucks” queries may be associated with 2878 distinct locations specified implicitly or explicitly. Because the searches come from so many different locations, “starbucks” may appear to be a general term, and not the title of a specific chain business. However, the server may also consider the business listing data. There may be 9955 listings with the title “starbucks”. So the ratio of the number of unique locations to the number of listings sharing the name would be 2878/9955, or 0.288. In this example if the threshold is 2.0, as 0.288 is less than 2.0, the server may determine that “starbucks” is a chain business query.

In another example, on average, there may be 13897 queries each day for “flowers”. These queries may include 483 distinct locations specified implicitly or explicitly. Turning to the business listings, there may be only 81 listings including the title “flowers.” Here, the ratio of th enuso this time the ratio of the number of unique locations to the number of listings sharing the name would be 483/81, or 5.96. As 5.96 is greater than the threshold value of 2.0, the server may determine that the term “flowers” is not a chain business.

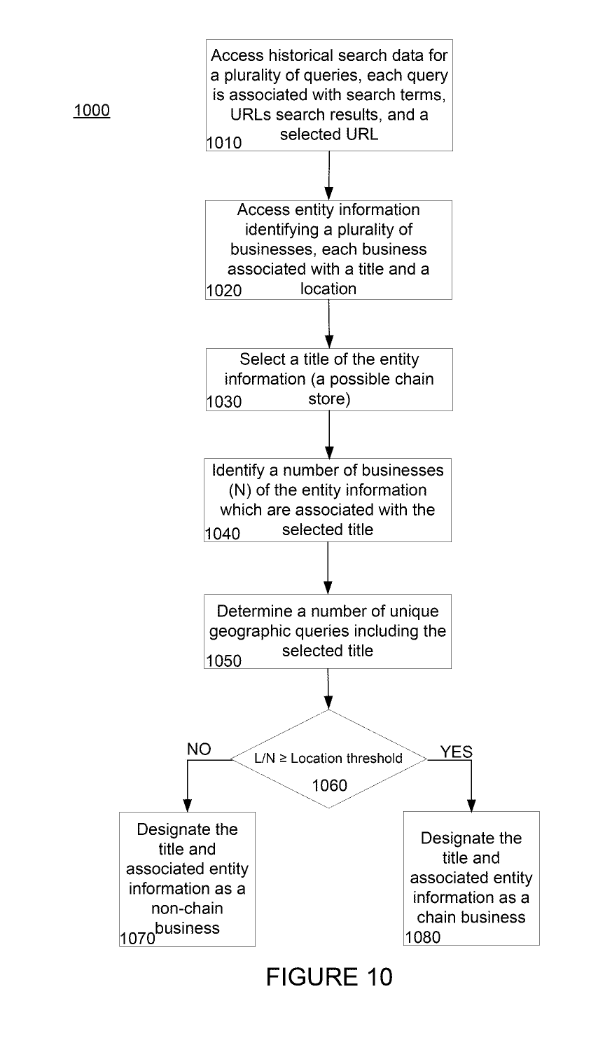

For example, as shown in process 1000 of FIG. 10, a server may access historical search data 136 at block 1010. The server also accesses the entity information 138 at block 1020. The server then selects a possible chain business title, for example identified by reviewing the entity information 138 for business entries with the same titles or categories or selecting a title of a predetermined list, at block 1030. The server may review the entity information 138 to determine a number N of businesses (and the businesses themselves) where each of the businesses is associated with the selected title at block 1040. The server then determines from the historical search data, the number L of unique geographical queries (map searches) including the selected title at block 1050. The server then compares the ratio of the number of locations to number of businesses to (L/N) to a location threshold value at block 1060. If the location threshold is greater than the ratio, the server determines that the title is a non-chain business and designates the title and associated entity information as a non-chain business at block 1070. If the location threshold is less than or equal to the ratio, the server determines that the title is a chain business and designates the title and associated entity information as a chain business at block 1080.

In another example, mentioned above, the “localness” score may be used to filter general terms from the list of perceived chain businesses. For example, queries with a higher localness score, or a score above a particular threshold value, may indicate that the query terms include a title which may be a chain business. By identifying search queries with a low localness score, the server may reject shared titles which are actually common terms such as “MySpace” or “Yahoo”. These queries may be issued very frequently in web searches but only rarely in web searches.

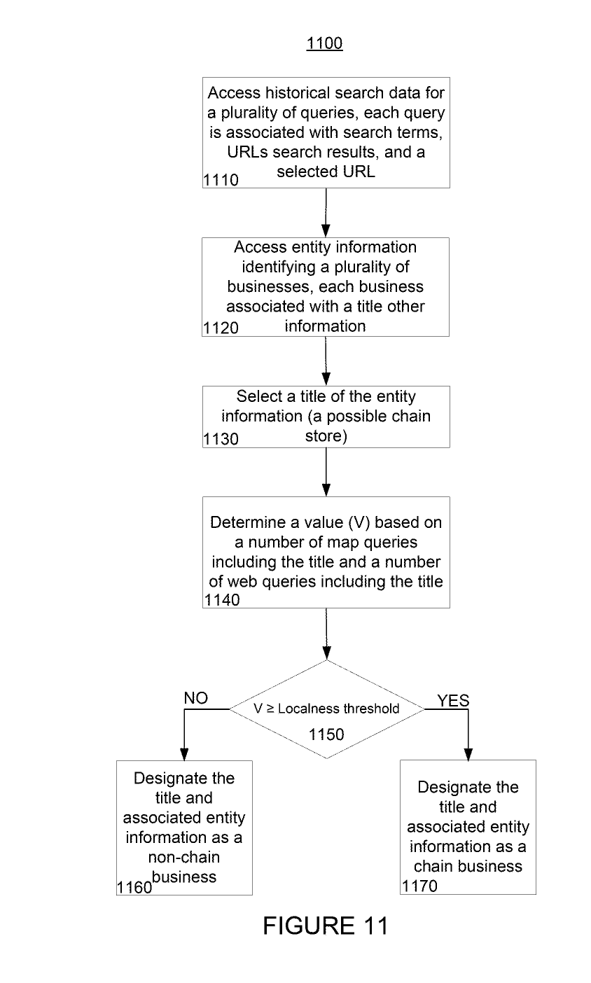

Process 1100 of FIG. 11 illustrates one example of localness scores. As shown in FIG. 11, the server accesses the historical search data 136 at block 1110. The server also accesses the entity information 138 at block 1120. The server then selects a possible chain business title at block 1130. The server identifies queries of the historical search data based on the selected title and generates a value V (localness score) based on the ratio of the number of map queries including the title to the number of web queries including the title at block 1130. The server then compares the value V to a localness threshold value at block 1150. If the localness threshold is greater than the value V, the server determines that the title is a non-chain business and designates the title and associated entity information as a non-chain business at block 1160. If the localness threshold is less than or equal to the value V, the server determines that the title is a chain business and designates the title and associated entity information as a chain business at block 1170.

In a further example, the server may filter the list of perceived chain businesses with titles which also appear in category names. For example, some category names may actually be valid titles, such as a provider category “Ikea”. In order to remedy this problem, the server may compare how often a term or phrase appears in a category to how often the term or phrase appears in listing titles. The server may reject the term or phrase if the ratio of the category occurrence frequency to the title occurrence frequency is above a chosen threshold. Consider the threshold ratio is 1.2. If a term appeared more than 1.2 times as often in the category versus the title, the term may be considered a category term, and not a valid chain name. Similarly if the term appeared less than 1.2 times as often as the category versus the title, the term may be considered a chain business.

In one example, the server may consider the number of times that a particular name appears in the title of a listing versus the number of time the same name appears in the category of a listing. The term “flowers” may appear in the title of 81 business listings, but may appear in the category of 2705 business listings. Thus, the ratio of category appearances to title appearances may be 2705/51 or 53.0. If the threshold ratio is 1.2, the term flowers may be considered a category term as opposed to a chain business. The term “Ikea” may appear in 35 titles of the business listings, but may only appear in 8 categories. Thus, the ratio may be 8/35, or 0.22. Since this is less than 1.2, the term “Ikea” may be considered a chain business. Accordingly, the server may filter the term “flowers” but not the term “Ikea.”

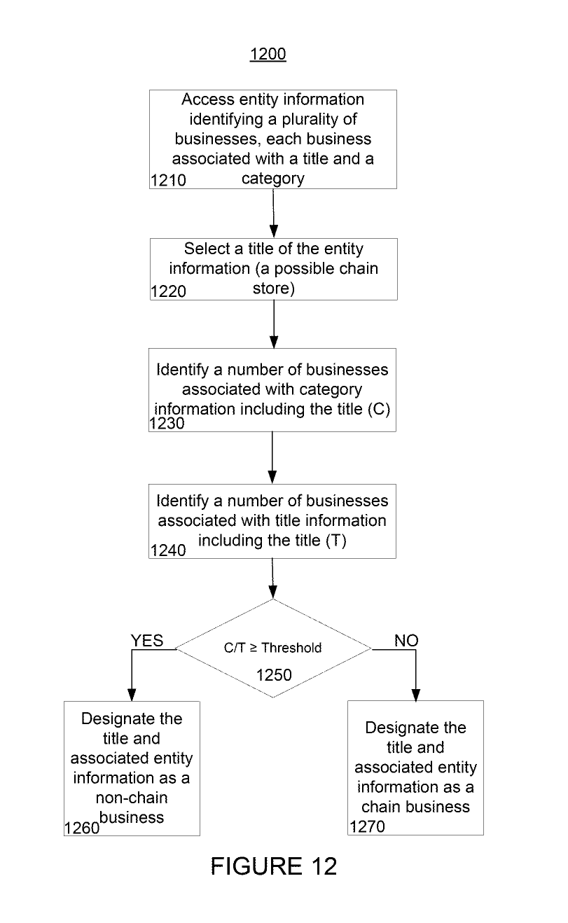

For example, as shown in FIG. 12, a server accesses the entity information 138 at block 1210. The server then selects a possible chain business title at block 1220. The server may review the entity information 138 to determine a number C of businesses associated with category information including the selected title at block 1230. The server may also review the entity information 138 to determine a number T of businesses associated with title information including the selected title at block 1240. The server then compares the ratio of the number of category occurrences to the number of title occurrences (C/T) to a threshold value at block 1250. If the location threshold is less than or equal to the ratio, the server determines that the title is a non-chain business and designates the title and associated entity information as a non-chain business at block 1260. If the location threshold is greater than the ratio, the server determines that the title is a chain business and designates the title and associated entity information as a chain business at block 1270.

It will be understood that these filters may be used independently or two or more together to determine whether or not a business of the entity information is in fact a chain business. In addition to being used as filters, the above examples may also be used to generate a prominence score in order to rank search results based on the likelihood that a search result is chain business. A business listing identified as a search result may be considered more or less prominent based on the likelihood that the business listing is actually a chain business listing. More prominent business listings may be displayed towards the top of a list of displayed search results.

For example, the server may calculate a prominence score for a particular business listing search result including the title “post office.” There may be 1447 business listings with the title “post office”. The server may want to know whether this is a chain business. The server may determine the localness score to be 7.4, meaning the query “post office” has 7.4 times the traffic in map queries than web queries. This may be high enough to consider the term to have local intent. Based on this information, the server may determine that “post office” may be a chain business.

Next, the server may examine the number of query locations. The query “post office” may be issued from 3810 distinct locations, so the ratio of the number of distinct locations to the number of business listings sharing the name may be 3810/1447=2.63. This is greater than a threshold ratio of 2.0. Based on this information, the server may determine that “post office” is not a chain business.

The server may examine the number of appearances in categories versus appearances in titles. The term “Post office” may occur as a listing title 1447 times and as a listing category 37420 times. Thus, the ratio of category occurrence to title occurrence may 37420/1447, or 25.86. This is higher than the threshold of 1.2, indicating that “post office” may more likely a category than a title. Accordingly, based on this information the server may again determine that “post office” is not a chain business. Considering these three factors together, the server may generate a prominence signal which suggests that the term “post office” likely not a chain business.

In one embodiment, the server may also use the contents of a website to identify chain businesses. The server may scan or search the website's information for one or more of the trigger terms. For example, the website may a link which is displayed as “store locator.” As described above, the use of such a trigger terms may indicate that this is a website for a chain business. The server may then identify the business associated with the website as a chain business. Thus, if the server receives a search query for the business associated with the website, the server may identify the request as a chain business query. Thus, websites may be used to identify both chain queries and chain businesses.

Once a plurality of entities have been identified as a chain business, the server may use this information to identify trigger terms 140. As described above, the trigger terms may be identified by using the list of known chain business names and searching the historical search data for terms which most frequently occur together with the known chain business names.

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A computer-implemented method for generating a table of chain businesses, the method comprising:
receiving a trigger term that is indicative of a user query for information related to a chain business;
identifying a plurality of queries from a historical data store that includes the trigger term and a particular name of a business;
identifying a most commonly selected search result of the search results presented in response to each of the plurality of queries;
generating, by a processor of a computer, an entry in the table of chain businesses, the entry including the particular name of the business and the identified most commonly selected search result; and
storing the table in memory.

2. The method of claim 1, further comprising:
receiving, from a processor of a second computer, a request including a search term; and
comparing the received search term to the particular name of the business of the table to determine if the received request is a request for information for a chain business.

3. The method of claim 2, further comprising, when the received search term is a chain business term, identifying the most commonly selected search result from the table.

4. The method of claim 2, further comprising:
receiving the location of the second computer;
identifying one or more business locations associated with the particular name of the business;
determining, based on the received location, a closest business location of the one or more business locations closest to the client device; and
transmitting for display on the second computer a map identifying the closest business location and a list of search results.

5. (canceled)

6. A computer-implemented method for determining chain business titles, the method comprising:
identifying a number of businesses having a title of a possible chain business based on entity information describing, for each of a plurality of businesses, a title of that business;
identifying a number of unique geographic location queries from a historical search data store that include the title of the possible chain business and implicitly or explicitly include a unique geographic location;
determining, by a processor, a ratio based on the number of businesses and the number of unique geographic location queries; and
determining whether the title of the possible chain business is a chain business title by comparing the determined ratio to a threshold value.

7. The method of claim 6, wherein the ratio is a ration of the number of unique location queries to the number of businesses.

8. The method of claim 6, further comprising, when it is determined that the title of the possible chain business is not a chain business title, removing the possible chain business from a list of possible chain businesses.

9. The method of claim 6, further comprising designating the possible chain business as a chain business when the ratio satisfies the threshold value.

10. (canceled)

11. A computer-implemented method for determining chain business titles, the method comprising:
identifying, from a historical search data store, a number of map queries including a search term having a title of a possible chain business;
identifying, from the historical search data store, a number of web queries including a search term having the title of the possible chain business;
determining, with a processor, a ratio based on both the number of map queries and the number of web queries; and
determining whether the title of the possible chain business is a chain business title by comparing the determined ratio to a threshold value.

12. The method of claim 11, further comprising determining that the title of the possible chain business is not a name of a chain business when the determined ratio does not satisfy the threshold value.

13. The method of claim 12, further comprising removing the possible chain business from a list of possible chain businesses.

14. (canceled)

15. The method of claim 11, wherein the determined ratio is a ratio of the number of map queries to the number of web queries.

16. A computer-implemented method for determining chain business titles, the method comprising:
identifying, from entity information identifying businesses having business titles and business categories, a number T of businesses having business categories that including a title of a possible chain business;
identifying, from the entity information, a number C of businesses having business titles including the title of the possible chain business;
determining, by a processor, a ratio based on the number T and the number C; and
determining that the title of the possible chain business a chain business title by comparing the determined ratio to a threshold value.

17. The method of claim 16, further comprising determining that the title of the possible chain business is not a chain business title when the determined value does not satisfy the threshold value.

18. The method of claim 17, further comprising removing the possible chain business from a list of possible chain businesses.

19. (canceled)

20. The method of claim 16, wherein the determined ratio is a ratio of the number T to the number C.

21. The method of claim 1, further comprising identifying a second plurality of queries from the historical data store having a most commonly selected search result of the search results presented in response to that query that is a same as the most commonly selected search result of the search results presented in response to each of the plurality of queries, and wherein the generating is further based on the second plurality of queries.
